(19) United States
(12) Patent Application Publication
(10) Pub. No.: US 2013/0057515 A1
(43) Pub. Date: Mar. 7, 2013

(54) DEPTH CAMERA AS A TOUCH SENSOR

(71) Applicant: Andrew David Wilson, Seattle, WA (US)

(72) Inventor: Andrew David Wilson, Seattle, WA (US)

(73) Assignee: Microsoft Corporation, Redmond, WA (US)

(21) Appl. No.: 13/227,466

(22) Filed: Sep. 7, 2011

(51) Int. Cl. G06F 3/042

(52) U.S. Cl. 345/175

(57) ABSTRACT

Architecture that employs depth sensing cameras to detect touch on a surface, such as a tabletop. The act of touching is processed using thresholds which are automatically computed from depth image data, and these thresholds are used to generate a touch image. More specifically, the thresholds (near and far, relative to the camera) are used to segment a typical finger that touches a surface. A snapshot image is captured of the scene and a surfaced histogram is computed from the snapshot over a small range of deviations at each pixel location. The near threshold (nearest to the camera) is computed based on the anthropometry of fingers and hands, and associated posture during touch. After computing the surface histogram, the far threshold values (furthest from the camera) can be stored as an image of thresholds, used in a single pass to classify all pixels in the input depth image.

### BACKGROUND

The limits of depth estimate resolution and line of sight requirements dictate that the determination of the moment of touch will not be as precise as that of more direct sensing techniques such as capacitive touch screens. Depth sensing cameras report distance to the nearest surface at each pixel. However, given the depth estimate resolution of today's depth sensing cameras, and the various limitations imposed by viewing the user and table from above, relying exclusively on the depth camera will not give a sufficiently precise determination of the moment of touch.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture employs depth sensing cameras to detect touch on a surface, such as a tabletop. The touch can be attributed to a specific user as well. The act of touching is processed using thresholds which are automatically computed from depth image data, and these thresholds are used to generate a touch image.

More specifically, the thresholds (near and far, relative to the camera) are used to segment a typical finger that touches a surface. A snapshot image is captured of the scene and a surfaced histogram is computed from the snapshot over a small range of deviations at each pixel location. The near threshold (nearest to the camera) is computed based on the anthropometry of fingers and hands, and associated posture during touch. After computing the surface histogram, the far threshold values (furthest from the camera) can be stored as an image of thresholds, used in a single pass to classify all pixels in the input depth image.

The resulting binary image shows significant edge effects around the contour of the hand, which artifacts may be removed by low-pass filtering the image. Discrete points of contact may be found in this final image by techniques common to imaging interactive touch screens (e.g., connected components analysis may be used to discover groups of pixels corresponding to contacts). These may be tracked over time to implement familiar multi-touch interactions per user, for example.

Accordingly, as employed herein, use of a depth sensing camera to detect touches means that the interactive surface need not be instrumented. Moreover, the architecture enables touch sensing on non-flat surfaces, and information about the shape of the user and user appendages (e.g., arms and hands) above the surface may be exploited in useful ways, such as determining hover state and, that multiple touches are from same hand, and/or from the same user.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates a depth sensing camera touch system.

FIG. 3 illustrates a method in accordance with the disclosed architecture.

FIG. 4 illustrates further aspects of the method of FIG. 3.

FIG. 5 illustrates an alternative method.

FIG. 6 illustrates further aspects of the method of FIG. 5.

FIG. 7 illustrates a block diagram of a computing system that executes touch processing in accordance with the disclosed architecture.

### DETAILED DESCRIPTION

The disclosed architecture utilizes a depth sensing camera to emulate touch screen sensor technology. In particular, a useful touch signal can be deduced when the camera is mounted above a surface such as a desk top or table top. In comparison with more traditional techniques, such as capacitive sensors, the use of depth sensing cameras to sense touch means that the interactive surface need not be instrumented, need not be flat, and information about the shape of the users and user arms and hands above the surface may be exploited in useful ways. Moreover, the depth sensing camera may be used to detect touch on an un-instrumented surface. The architecture facilitates working on non-flat surfaces and in concert with “above the surface” interaction techniques.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

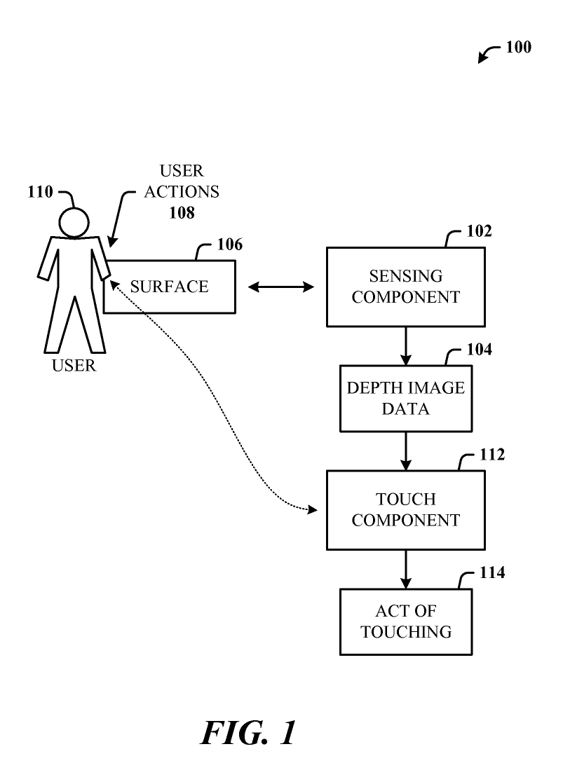

FIG. 1 illustrates a system 100 in accordance with the disclosed architecture. The system 100 includes a sensing component 102 (e.g., a depth sensing camera) that senses depth image data 104 of a surface 106 relative to which user actions 108 of a user 110 are performed, and a touch component 112 that determines an act of touching 114 the surface 106 based on the depth image data 104 of the image of the surface 106.

The touch component 112 can compute a model of the surface that includes depth deviation data at each pixel location as the depth image data 104 (e.g., the model can be represented as a histogram, probability mass function, probability distribution function, etc.) of the image. The touch component 112 can classify pixels of the depth image data 104 according to threshold values. The touch component 112 can compute physical characteristics (e.g., user hand, user arm, etc.) of the user 110 as sensed by the sensing component 102 to interpret the user actions 108. The touch component 112 establishes a maximum threshold value based on a histogram of depth values and finds a first depth value that exceeds a threshold value as the maximum threshold value. The sensing component 102 captures a snapshot of the depth image data 104 of the surface 106 during an unobstructed view of the surface 106 and the touch component 112 models the surface 106 based on the depth image data 104. The touch component 112 identifies discrete touch points using filtering and associated groups of pixels that correspond to the touch points. The touch component 112 tracks the touch points over time to implement familiar multi-touch interactions.

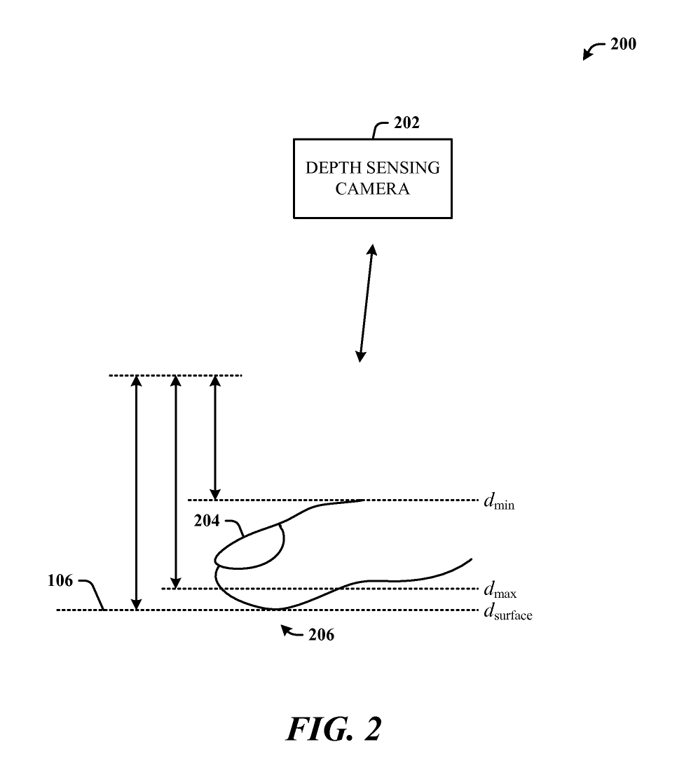

FIG. 2 illustrates a depth sensing camera touch system 200. The system 200 employs a depth sensing camera 202 (and optionally, additional cameras) to view and sense the surface and user interactions relative to the surface.

Assuming a clear line of sight from the camera 202 to the surface 106, one approach to detect touch using the depth sensing camera 202 is to compare the current input depth image against a model of the touch surface 106. Pixels corresponding to a finger 204 or hand appear to be closer to the camera 202 than the corresponding part of the known touch surface.

Utilizing all pixels closer than a threshold value as representing the depth of the surface 106, also includes pixels belonging to the user's arm and potentially other objects that are not in contact with the surface (e.g., tabletop). A second threshold may be used to eliminate pixels that are too far from the surface 106 to be considered part of the object (e.g., finger) in contact:

dₘₐₓ>d_{x,y}>dₘᵢₙ (1)

where dₘᵢₙ is the minimum distance to the depth camera 202 (farthest from the surface 106), dₘₐₓ is the maximum distance to the depth camera 202 (closest to the surface 106), and d_{x,y} is a value between the minimum and maximum distances. This relation establishes a “shell” around the area of interest of the surface 106. Following is a description of one implementation for setting the values of dₘₐₓ and dₘᵢₙ.

The above approach relies on estimates of the distance to the surface 106 at every pixel in the image. The value of dₘₐₓ can be as large as possible without misclassifying a number of the non-touch pixels. The value dₘₐₓ can be chosen to match the known distance to the surface 106, d_{surface}, with some margin to accommodate any noise in the depth image values. Setting this value dₘₐₓ too loosely risks visually “cutting off the tips of fingers”, which can cause an undesirable shift in contact position in later stages of processing.

For flat surfaces, such as a table, the 3D (three-dimensional) position and orientation of the surface 106 can be modeled, and surface distance d_{surface} computed at given image coordinates based on the model. However, this idealized model does not account for the deviations due to noise in the depth image, slight variations in surface flatness, or uncorrected lens distortion effects. Thus, dₘₐₓ is placed some distance above d_{surface} to account for these deviations from the model. In order to provide an optimized touch signal, the distance d_{surface}−dₘₐₓ is minimized.

One improved approach is to find d_{surface} for every pixel location by taking a “snapshot” of the depth image when the surface 106 is empty. This non-parametric approach can model surfaces that are not flat (with a limitation that the sensed surface has a line-of-sight to the camera).

However, depth image noise at a given pixel location is neither normal nor the same at every pixel location. Depth can be reported in millimeters as 16-bit integer values (these real world values can be calculated from raw shift values—also 16-bit integers). A per-pixel histogram of raw shift values over several hundred frames of a motionless scene reveals that depth estimates can be stable at many pixel locations, taking on only one value, but at other locations can vacillate between two adjacent values.

In one implementation, dₘₐₓ is determined at each pixel location by inspecting the histogram, and considering depth values from least depth to greatest depth, finding the first depth value for which histogram exceeds some small threshold value. Rather than building a full 16-bit histogram over the image, a “snapshot” of the scene can first be taken and then a histogram computed over a small range of deviations from the snapshot at each pixel location.

Setting the minimum distance dₘᵢₙ is less straightforward: too low of a value (too near) will cause touch contacts to be generated well before there is an actual touch. Too great of a value (too far) may make the resulting image of classified pixels difficult to group into distinct contacts. Setting dₘᵢₙ too low or too high causes a shift in contact position.

In one embodiment, an assumption is made about the anthropometry of fingers and hands, and associated posture during touch. The minimum distance dₘᵢₙ can be chosen to match the typical thickness τ of the finger 204 resting on the surface 106, and it can be assumed that the finger 204 lies flat on the surface 106 at least along the area of contact 206: dₘₐₓ=dₘᵢₙ−τ.

With respect to forming contacts, after computing the surface histogram, the values dₘₐₓ may be stored as an image of thresholds, used in a single pass to classify all pixels in the input depth image according to Equation (1).

The resulting binary image may show significant edge effects around the contour of the hand, even when the hand is well above the minimum distance dₘᵢₙ. However, these artifacts may be removed by low-pass filtering the image; such as a separable boxcar filter (e.g., 9×9 pixels) followed by thresholding to obtain regions where there is good information for full contact actions. Discrete points of contact may be found in this final image by techniques common to imaging interactive touch screens. For example, connected components analysis may be used to discover groups of pixels corresponding to contacts. These may be tracked over time to implement familiar multi-touch interactions.

The depth sensing camera computes depth at each pixel by triangulating features, and the resolution of the depth information decreases with camera distance.

In one exemplary implementation, the camera can be configured to report depth shift data in a 640×480 16-bit image at 30 Hz. The threshold dₘₐₓ is set automatically by collecting a histogram of depth values of the empty surface over a few hundred frames. Values of τ=4 and τ=7 (depth shift values, not millimeter) yield values for dₘᵢₙ=dₘₐₓ−τ, for the 0.75 m height and 1.5 m height configurations, respectively. These values result in sufficient contact formation, as well as the ability to process much of the hand when the hand is flat on the surface. The system can also operate on non-flat surfaces, which might include a book, and can detect touch on the book.

Depth sensing cameras enable a wide variety of interactions that go beyond any conventional touch screen sensor. In particular to interactive surface applications, depth cameras can provide more information about the user doing the touching. Segmentation of the user above the calibrated surface can be detected. For example, depth cameras are well suited to enable “above the surface” interactions, such as picking up a virtual object, “holding” it in the air above the surface, and dropping it elsewhere.

One particularly basic calculation that is useful in considering touch interfaces is the ability to determine that multiple touch contacts are from the same hand, or that multiple contacts are from the same user. Such connectivity information is calculated by noting that two contacts made by the same user index into the same “above the surface” component.

Extensions to the disclosed architecture can include recognition of physical objects placed and possibly moved on the surface, as distinct being from touch contacts. To then detect touching these objects, the surface calibration may be updated appropriately. Dynamic calibration can also be useful when the surface itself is moved. Another extension is the accuracy of the calculation of contact position can be improved by utilizing shape and/or posture information available in the depth camera. This can include corrections based on the user's eye-point, which may be approximated directly from the depth image by finding the user's head position. Note also that a particular contact can be matched to that user's body.

Additionally, other depth sensing camera technologies can be employed, such as time-of-flight-based depth cameras, for example, which have different noise characteristics and utilize a more involved histogram of depth values at each pixel location.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

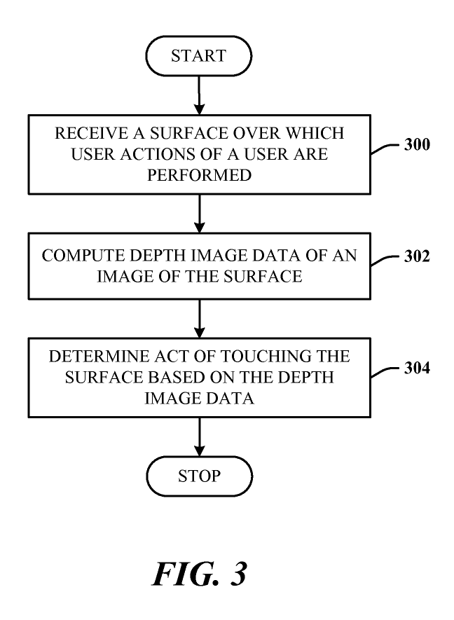

FIG. 3 illustrates a method in accordance with the disclosed architecture. At 300, a surface is received over which user actions of a user are performed. At 302, depth image data of an image of the surface is computed. At 304, an act of touching the surface is determined based on the depth image data.

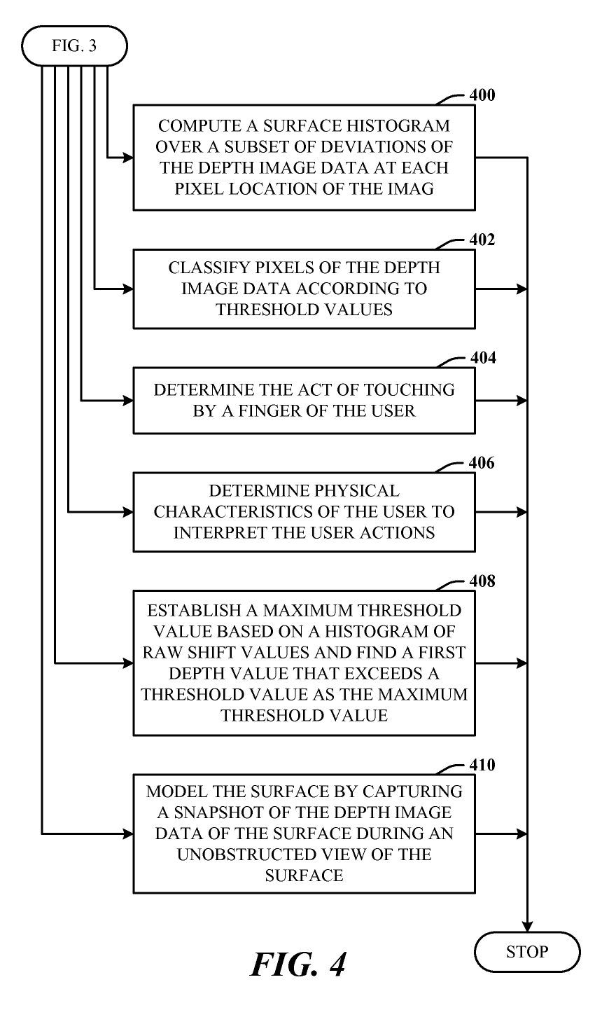

FIG. 4 illustrates further aspects of the method of FIG. 3. Note that the flow indicates that each block can represent a step that can be included, separately or in combination with other blocks, as additional aspects of the method represented by the flow chart of FIG. 3. At 400, a surface histogram is computed over a subset of deviations of the depth image data at each pixel location of the image. At 402, pixels of the depth image data are classified according to threshold values. At 404, the act of touching by a finger of the user is determined. At 406, physical characteristics of the user are determined to interpret the user actions. At 408, a maximum threshold value is established based on a histogram of raw shift values and a first depth value found that exceeds a threshold value as the maximum threshold value. At 410, the surface is modeled by capturing a snapshot of the depth image data of the surface during an unobstructed view of the surface.

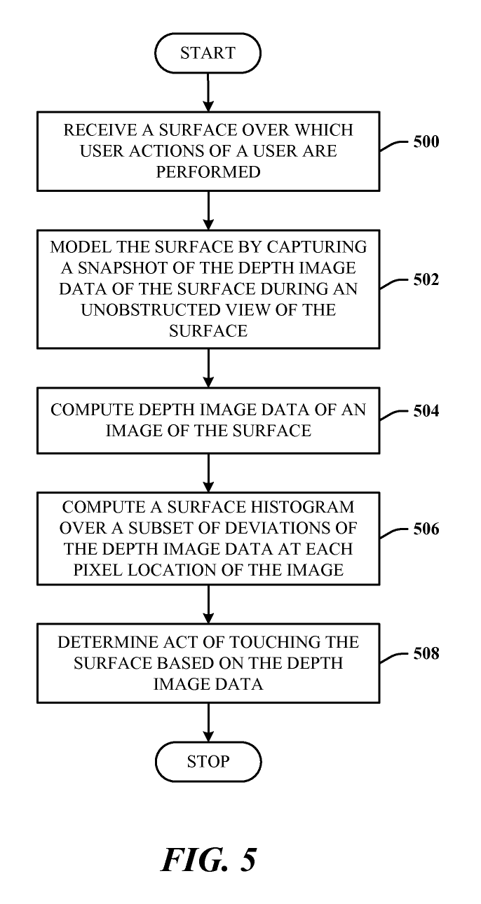

FIG. 5 illustrates an alternative method. At 500, a surface is received over which user actions of a user are performed. At 502, the surface is modeled by capturing a snapshot of the depth image data of the surface during an unobstructed view of the surface. At 504, depth image data of an image of the surface is computed. At 506, a surface histogram is computed over a subset of deviations of the depth image data at each pixel location of the image. At 508, an act of touching the surface is determined based on the depth image data.

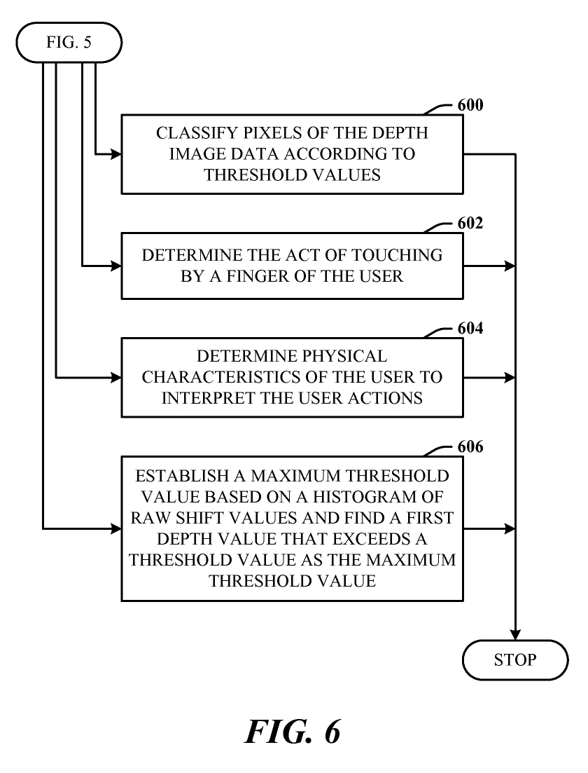

FIG. 6 illustrates further aspects of the method of FIG. 5. Note that the flow indicates that each block can represent a step that can be included, separately or in combination with other blocks, as additional aspects of the method represented by the flow chart of FIG. 5. At 600, pixels of the depth image data are classified according to threshold values. At 602, the act of touching by a finger of the user is determined. At 604, physical characteristics of the user are determined to interpret the user actions. At 606, a maximum threshold value is established based on a histogram of raw shift values and a first depth value found that exceeds a threshold value as the maximum threshold value.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in volatile or non-volatile storage media), a module, a thread of execution, and/or a program. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

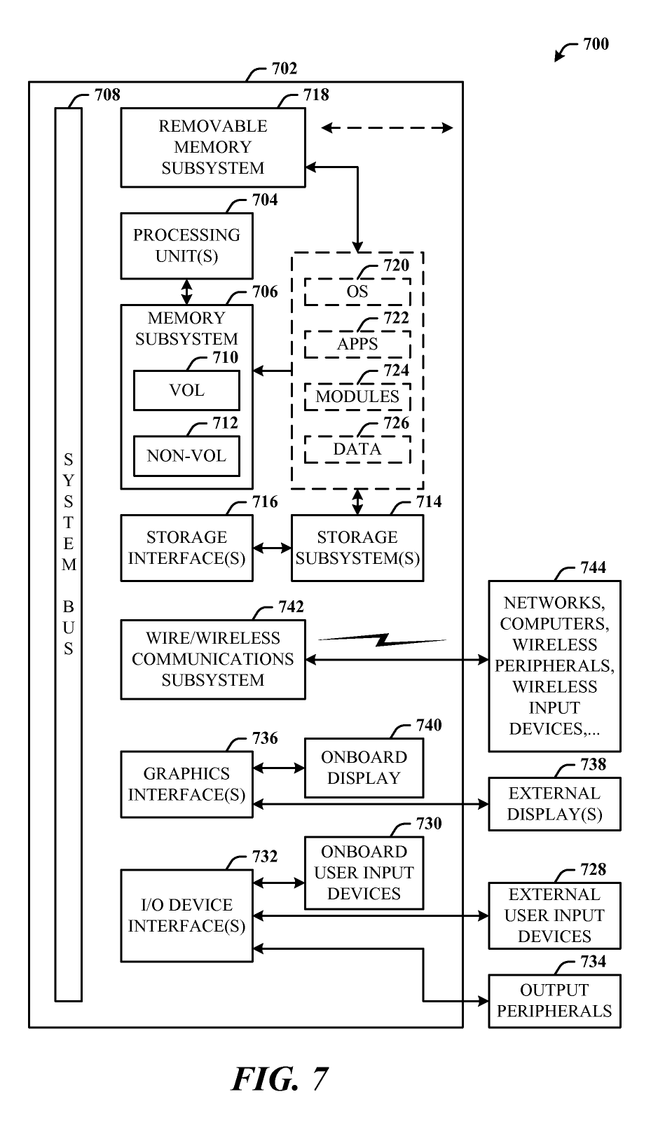

Referring now to FIG. 7, there is illustrated a block diagram of a computing system 700 that executes touch processing in accordance with the disclosed architecture. However, it is appreciated that the some or all aspects of the disclosed methods and/or systems can be implemented as a system-on-a-chip, where analog, digital, mixed signals, and other functions are fabricated on a single chip substrate. In order to provide additional context for various aspects thereof, FIG. 7 and the following description are intended to provide a brief, general description of the suitable computing system 700 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 700 for implementing various aspects includes the computer 702 having processing unit(s) 704, a computer-readable storage such as a system memory 706, and a system bus 708. The processing unit(s) 704 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 706 can include computer-readable storage (physical storage media) such as a volatile (VOL) memory 710 (e.g., random access memory (RAM)) and non-volatile memory (NON-VOL) 712 (e.g., ROM, EPROM, EEPROM, etc.). A basic input/output system (BIOS) can be stored in the non-volatile memory 712, and includes the basic routines that facilitate the communication of data and signals between components within the computer 702, such as during startup. The volatile memory 710 can also include a high-speed RAM such as static RAM for caching data.

The system bus 708 provides an interface for system components including, but not limited to, the system memory 706 to the processing unit(s) 704. The system bus 708 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 702 further includes machine readable storage subsystem(s) 714 and storage interface(s) 716 for interfacing the storage subsystem(s) 714 to the system bus 708 and other desired computer components. The storage subsystem(s) 714 (physical storage media) can include one or more of a hard disk drive (HDD), a magnetic floppy disk drive (FDD), and/or optical disk storage drive (e.g., a CD-ROM drive DVD drive), for example. The storage interface(s) 716 can include interface technologies such as EIDE, ATA, SATA, and IEEE 1394, for example.

One or more programs and data can be stored in the memory subsystem 706, a machine readable and removable memory subsystem 718 (e.g., flash drive form factor technology), and/or the storage subsystem(s) 714 (e.g., optical, magnetic, solid state), including an operating system 720, one or more application programs 722, other program modules 724, and program data 726.

The operating system 720, one or more application programs 722, other program modules 724, and/or program data 726 can include entities and components of the system 100 of FIG. 1, entities and components of the system 200 of FIG. 2, and the methods represented by the flowcharts of FIGS. 3-6, for example.

Generally, programs include routines, methods, data structures, other software components, etc., that perform particular tasks or implement particular abstract data types. All or portions of the operating system 720, applications 722, modules 724, and/or data 726 can also be cached in memory such as the volatile memory 710, for example. It is to be appreciated that the disclosed architecture can be implemented with various commercially available operating systems or combinations of operating systems (e.g., as virtual machines).

The storage subsystem(s) 714 and memory subsystems (706 and 718) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that can be accessed by the computer 702 and includes volatile and non-volatile internal and/or external media that is removable or non-removable. For the computer 702, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 702, programs, and data using external user input devices 728 such as a keyboard and a mouse. Other external user input devices 728 can include a microphone, an IR (infrared) remote control, a joystick, a game pad, camera recognition systems, a stylus pen, touch screen, gesture systems (e.g., eye movement, head movement, etc.), and/or the like. The user can interact with the computer 702, programs, and data using onboard user input devices 730 such a touchpad, microphone, keyboard, etc., where the computer 702 is a portable computer, for example. These and other input devices are connected to the processing unit(s) 704 through input/output (I/O) device interface(s) 732 via the system bus 708, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 732 also facilitate the use of output peripherals 734 such as printers, audio devices, camera devices, and so on, such as a sound card and/or onboard audio processing capability.

One or more graphics interface(s) 736 (also commonly referred to as a graphics processing unit (GPU)) provide graphics and video signals between the computer 702 and external display(s) 738 (e.g., LCD, plasma) and/or onboard displays 740 (e.g., for portable computer). The graphics interface(s) 736 can also be manufactured as part of the computer system board.

The computer 702 can operate in a networked environment (e.g., IP-based) using logical connections via a wired/wireless communications subsystem 742 to one or more networks and/or other computers. The other computers can include workstations, servers, routers, personal computers, microprocessor-based entertainment appliances, peer devices or other common network nodes, and typically include many or all of the elements described relative to the computer 702. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 702 connects to the network via a wired/wireless communication subsystem 742 (e.g., a network interface adapter, onboard transceiver subsystem, etc.) to communicate with wired/wireless networks, wired/wireless printers, wired/wireless input devices 744, and so on. The computer 702 can include a modem or other means for establishing communications over the network. In a networked environment, programs and data relative to the computer 702 can be stored in the remote memory/storage device, as is associated with a distributed system. It will be appreciated that the network connections shown are exemplary and other means of establishing a communications link between the computers can be used.

The computer 702 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a sensing component that senses depth image data of a surface relative to which user actions of a user are performed;
a touch component that determines an act of touching the surface based on the depth image data; and
a processor that executes computer-executable instructions associated with at least one of the sensing component or the touch component.

2. The system of claim 1, wherein the touch component computes a model of the surface that includes depth deviation data at each pixel location as the depth image data.

3. The system of claim 1, wherein the touch component classifies pixels of the depth image data according to threshold values.

4. The system of claim 1, wherein the touch component computes physical characteristics of the user as sensed by the sensing component to interpret the user actions.

5. The system of claim 1, wherein the touch component establishes a maximum threshold value based on a histogram of depth values and finds a first depth value that exceeds a threshold value as the maximum threshold value.

6. The system of claim 1, wherein the sensing component captures a snapshot of the depth image data of the surface during an unobstructed view of the surface and the touch component models the surface based on the depth image data.

7. The system of claim 1, wherein the touch component identifies discrete touch points using filtering and associated groups of pixels that correspond to the touch points.

8. The system of claim 7, wherein the touch component tracks the touch points over time to implement familiar multi-touch interactions.

9. A method, comprising acts of:
receiving a surface over which user actions of a user are performed;
computing depth image data of an image of the surface;
determining an act of touching the surface based on the depth image data; and
utilizing a processor to execute instructions stored in memory to perform at least one of the acts of computing or determining.

10. The method of claim 9, further comprising computing a surface histogram over a subset of deviations of the depth image data at each pixel location of the image.

11. The method of claim 9, further comprising classifying pixels of the depth image data according to threshold values.

12. The method of claim 9, further comprising determining the act of touching by a finger of the user.

13. The method of claim 9, further comprising determining physical characteristics of the user to interpret the user actions.

14. The method of claim 9, further comprising establishing a maximum threshold value based on a histogram of raw shift values and finding a first depth value that exceeds a threshold value as the maximum threshold value.

15. The method of claim 9, further comprising modeling the surface by capturing a snapshot of the depth image data of the surface during an unobstructed view of the surface.

16. A method, comprising acts of:
receiving a surface over which user actions of a user are performed;
modeling the surface by capturing a snapshot of the depth image data of the surface during an unobstructed view of the surface;
computing depth image data of an image of the surface;
computing a surface histogram over a subset of deviations of the depth image data at each pixel location of the image;
determining an act of touching the surface based on the depth image data; and
utilizing a processor to execute instructions stored in memory to perform at least one of the acts of modeling, computing, or determining.

17. The method of claim 16, further comprising classifying pixels of the depth image data according to threshold values.

18. The method of claim 16, further comprising determining the act of touching by a finger of the user.

19. The method of claim 16, further comprising determining physical characteristics of the user to interpret the user actions.

20. The method of claim 16, further comprising establishing a maximum threshold value based on a histogram of raw shift values and finding a first depth value that exceeds a threshold value as the maximum threshold value.
